(19) United States
(12) Patent Application Publication
(10) Pub. No.: US 2007/0031685 A1
(43) Pub. Date: Feb. 8, 2007

(54) Silicone photoluminescent layer and process for manufacturing the same

(75) Inventors: Youngwook Ko, Daejeon-Si (KR); Jun Ho Song, Seoul (KR)

Correspondence Address: JENKENS & GILCHRIST, P.C., 901 15TH STREET N.W., SUITE 900, WASHINGTON, DC, 20005, US

(73) Assignee: KDT Co. Ltd., Chung-Woon Gun (KR)

(21) Appl. No.: 11/298,624

(22) Filed: Dec. 12, 2005

(30) Foreign Application Priority Data
Aug. 3, 2005 (KR) 10-2005-0070934

(51) Int. Cl. B32B 25/20; B32B 5/16; B32B 3/00; B05D 5/00

(52) U.S. Cl. 428/447; 428/690; 428/480; 428/522; 428/412; 428/523; 428/323; 427/157; 427/387; 427/256

(57) ABSTRACT

A photoluminescent layer including a silicone resin film; at least one color of phosphors distributed throughout the silicone resin film; and a base film on a first surface of the silicone resin film.

The present invention claims the benefit of Korean Patent Application No. 10-2005-0070934 filed in Korea on Aug. 3, 2005, which is hereby incorporated by reference in its entirety.

### BACKGROUND OF THE INVENTION

1. Field of the Invention

The present invention relates to a photoluminescent layer, and more particularly, to a silicone photoluminescent layer and a process for manufacturing the same. Although the present invention is suitable for a wide scope of applications, it is particularly suitable for wavelength conversion of a single wavelength of light into multiple wavelengths of light.

2. Discussion of the Related Art

In the related art, photoluminescent sheets having a structure in which wavelength conversion-type phosphors are impregnated into a organic resin matrix. Such photoluminescent sheets, or color conversion sheets are used on backlight units for display devices, such as liquid crystal displays. Among such photoluminescent sheets, Japanese Patent Publication Laid-open No. Hei 11-199781, entitled “Color Conversion Sheet And Luminescent Device Using The Same,” discloses a color conversion sheet having an organic resin containing an inorganic phosphor absorbing at least a portion of blue light transmitted through the color conversion sheet. A light having a longer wavelength than the blue light is emitted by this color conversion sheet as a result of absorbing at least a portion of the blue light. The color conversion sheet exhibits high strength, high impact resistance, a reduced concentration of impurities and improved heat resistance. Further, such a color conversion sheet emits bright light over a range of wavelengths even with a high concentration of phosphors present in the organic resin. These characteristics are achieved by using cerium-doped yttrium-aluminum-garnet based fluorescent substance as the phosphor, and polyarylate or polycarbonate as the organic resin.

The preparation of the related art color conversion sheet as mentioned above, involves kneading an inorganic phosphor and a diffusing agent in a twin extruder along with an organic resin. Consequently, this process yields color conversion sheets that from batch to batch have inconsistent brightness, different color conversion capabilities, and non-uniform thicknesses due to differences in the heterogeneous mixing of the phosphor and diffusing agent for each batch. Further, as the thickness of the color conversion sheet becomes thinner, these problems, which are associated with mass production yield, increase and other process related problems occur. Because of these problems, it is difficult to prepare the related art diffusion sheets via extrusion molding.

To overcome such problems and disadvantages exhibited by the related art, related art photoluminescent diffusion sheets have been manufactured by spraying, screen printing or casting a solution containing dissolved thermoplastic organic resin, solvent, phosphors and diffusing agents. The spraying method has a disadvantage in that the resultant photoluminescent diffusion sheet from this process has an inconsistent thickness due to an inconsistent hardening of the materials in the course of spraying as the solvents evaporate. The screen printing and casting methods produce films having consistency within a few micrometers. However, both the screen printing method and the casting method require a large amount of solvent to control thickness and to maintain a consistent distribution of phosphors and diffusing agents. Because a large amount of solvent must be evaporated in both the screen printing method and the casting method, the resultant photoluminescent diffusion sheet from these processes becomes brittle and has low mechanical strength due to presence of both the phosphors and the diffusion agents in the resin. Further, the solvents used for inorganic resins tend to be toxic.

### SUMMARY OF THE INVENTION

Accordingly, the present invention is directed to a silicone photoluminescent layer and a process for manufacturing the same that substantially obviate one or more of the problems due to limitations and disadvantages of the related art.

An object of the present invention is to provide a silicone photoluminescent layer with a consistent thickness and a process for manufacturing the same.

Another object of the present invention is to provide a silicone photoluminescent layer with a reproducibly consistent mixture of phosphors and diffusing agents and a process for manufacturing the same.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the silicone photoluminescent layer and process for manufacturing the same includes a silicone resin film; at least one color of phosphors distributed throughout the silicone resin film; and a base film on a first surface of the silicone resin film.

In another aspect, a photoluminescent layer includes a light guide panel, a silicone resin film on the light guide panel, and at least one color of phosphors distributed throughout the silicone resin.

In yet another aspect, a method of making a photoluminescent layer includes mixing photoluminescent materials and liquid silicone resin to produce a liquid silicone mixture, applying the liquid silicone mixture to a base film, and curing the applied liquid silicone mixture to form a photoluminescent silicone film on the base film.

In a further aspect, a method of making a photoluminescent layer includes mixing photoluminescent materials and liquid silicone resin to produce a liquid silicone mixture, applying the liquid silicone mixture to a light guide plate, curing the applied liquid silicone mixture to form a photoluminescent silicone film on the base film.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a silicone photoluminescent diffusion layer according to a first embodiment of the present invention.

FIG. 2 shows a knife over roll coating method for applying a liquid silicone mixture to a base film.

FIG. 3 shows a knife over table coating method for applying a liquid silicone mixture to a base film.

FIG. 4 shows a floating knife coating method for applying a liquid silicone mixture to a base film.

FIG. 5 shows an L-head reverse roll coater method for applying a liquid silicone mixture to a base film.

FIG. 6 shows a nip-fed reverse roll coater method for applying a liquid silicone mixture to a base film.

FIG. 7 shows a pan-fed reverse roll coater method for applying a liquid silicone mixture to a base film.

FIG. 8 shows a roll coating method for applying a liquid silicone mixture to a base film.

FIG. 9 shows a calendar coating method for applying a liquid silicone mixture to a base film.

FIG. 10 shows a curtain coating method for applying a liquid silicone mixture to a base film.

FIG. 11 shows an extrusion coating method for applying a liquid silicone mixture to a base film.

FIG. 12 shows another extrusion coating method for applying a liquid silicone mixture to a base film.

FIG. 13 shows an inverted rod coating method for applying a liquid silicone mixture to a base film.

FIG. 14 shows a dip coating method for applying a liquid silicone mixture to a base film.

FIG. 15 is a silicone photoluminescent diffusion layer according to a second embodiment of the present invention.

FIG. 16 is a silicone photoluminescent diffusion layer according to a third embodiment of the present invention.

FIG. 17 shows optical spectrum of a silicone photoluminescent diffusion layer and a PMMA photoluminescent diffusion layer.

FIG. 18 shows a photoluminescent diffusion layer according to a fourth embodiment of the present invention.

FIG. 19 shows optical spectrum of the photoluminescent diffusion layer was fabricated via screen printing with and without the grid patterns.

FIG. 20 shows optical spectra of photoluminescent diffusion layers having different diffusing agents.

FIG. 21 shows optical spectra of the photoluminescent diffusion layer including a light guide panel as compared to a photoluminescent diffusion layer including a PET film.

### DESCRIPTION OF THE PREFERRED EMBODIMENTS

Reference will now be made in detail to the preferred embodiments of the present invention, examples of which are illustrated in the accompanying drawings. In accordance with embodiments of the present invention, a photoluminescent diffusion layer may be prepared in various forms by mixing a silicone resin with phosphor to make a liquid silicone mixture. In the alternative, both phosphor and a light diffusion material can be mixed with silicone resin to make a liquid silicone mixture that also contains a diffusion material. A silicone photoluminescent layer can be formed by printing the liquid silicone mixture onto the base film or coating the liquid silicone mixture onto the base film. Similarly, a silicone photoluminescent layer can be formed by printing the liquid silicone mixture containing a diffusion material onto the base film or coating the liquid silicone mixture containing a diffusion material onto the base film.

The silicone photoluminescent layer in embodiments of the present invention can include a single color of phosphors, such as a yellow phosphor. The yellow emission of light from the yellow phosphor together with blue light from a blue LED transiting through the silicone photoluminescent diffusion layer combine to make white light. The silicone photoluminescent layer in embodiments of the present invention can also include two colors of phosphors, such as yellow and red phosphors. The yellow emission of light from the yellow phosphor and the red emission of light from the red phosphor together with blue light from a blue LED transiting through the silicone photoluminescent layer combine to make white light with a fuller spectrum than a single phosphor silicone photoluminescent layer. In another alternative, the silicone photoluminescent layer in embodiments of the present invention can include three colors of phosphors, such as green, yellow and red phosphors. White light emission can occur using green, yellow and red phosphors without mixing with blue light from a blue LED. For example, a UV LED can be used that causes the green, yellow and red phosphors to respectively emit green, yellow and red light.

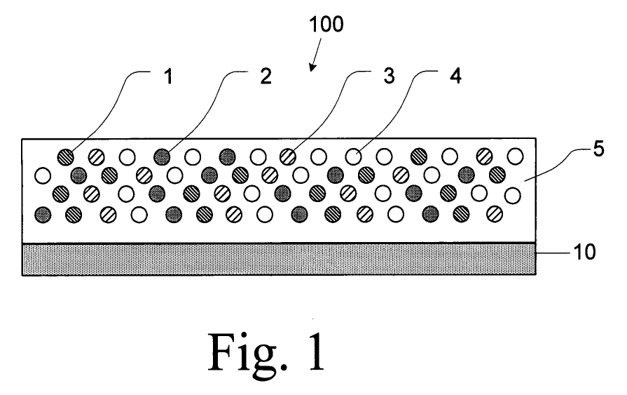

FIG. 1 is a silicone photoluminescent diffusion layer according to a first embodiment of the present invention. As shown in FIG. 1, the silicone photoluminescent diffusion layer 100 according to the first embodiment of the present invention includes a silicone resin film 5, which is positioned on a base film 10. The silicone resin film 5 contains photoluminescent materials and diffusion materials. Both of the photoluminescent materials and the diffusion materials are distributed throughout the silicone resin film 5. The photoluminescent materials can include yellow phosphors 1, green phosphors 2 and red phosphors 3. Further, the photoluminescent materials can include blue phosphors. The diffusion materials are light diffusing agents 4.

An inorganic phosphor can be employed as the photoluminescent material. For example, photoluminescent inorganic phosphor includes a phosphor in which a garnet (Gd)-based material, Y₃Al₅O₁₂ (YAG) is doped with cerium. In general, YAG-based phosphors are represented by (Y₁-x-yGdxCey)₃(A₁₁-zGaz)O₁₂ wherein x+y≦1; 0≦x≦1; 0≦y≦1; 0≦z≦1. For example, a yellow phosphor 1 is represented by photoluminescent material of (Y₁-x-yGdxCey)₃Al₅O₁₂ (YAG:Gd,Ce), (Y₁-xCex)₃Al₅O₁₂ (YAG:Ce), (Y₁-xCex)₃(A₁₁-yGay)₅O₁₂ (YAG:Ga,Ce), (Y₁-x-yGdxCey)₃(Al₅-zGaz)₅O₁₂(YAG:Gd,Ga,Ce), and (Gd₁-xCex)SC₂A₁₃O₁₂ (GSAG).

A main wavelength emitted from the photoluminescent material may vary depending upon kinds of the above-mentioned photoluminescent materials. Garnet composition-dependent Ce³⁺ emission enables various light emission ranging from green light with a wavelength of about 540 nm (YAG:Ga,Ce) to red light with a wavelength of about 600 nm (YAG:Gd,Ce), without reduction in light efficiency. In examples of embodiments of the present invention, (Y, Gd, Ce)₃(Al, Ga)₅O₁₂ (available from Daejoo Electronic Materials Co., Ltd., Korea) and Y₃Al₅O_{12:}Ce (available from Phosphor Technology Ltd., England) were employed. In addition, a representative inorganic red phosphor 3 in order to emit deep red light is SrB₄O₇:Sm²⁺. Sm²⁺ primarily contributes to emission of red wavelengths. In particular, the above-mentioned deep red inorganic phosphor absorbs the whole visible region having a wavelength of less than 600 nm, and emits deep red light, such as light having a wavelength of higher than 650 nm. In order to improve brightness, a SrS:Eu series phosphor having a wavelength of 620 nm (available from Phosphor Technology Ltd., England) can be employed.

A representative inorganic green phosphor 2 that emits green light is SrGa₂S4:Eu2+. Such an inorganic green-emitting phosphor absorbs light with a wavelength of lower than 500 nm, and emits a main wavelength of 535 mm. Further, a representative inorganic phosphor (2) that emits blue light is BaMg₂A₁₁₆O₂₇:Eu₂+. Such an inorganic blue-emitting phosphor absorbs light with a wavelength of less than 430 nm, and emits a main wavelength of 450 nm.

The diffusing agent 4 has a scattering and/or diffusing function for providing uniform light emission. The types of diffusing agents are broadly divided into a high molecular weight diffusing agent and an inorganic diffusing agent. The high molecular weight diffusing agent includes, for example, organic transparent diffusing agents such as acrylic resins, styrene resins and silicone resins, and the inorganic transparent diffusing agent such as synthetic silica, glass beads and diamond. The representative inorganic diffusing agents may be made of inorganic oxides, such as silicone dioxide (SiO₂), titanium dioxide (TiO₂), zinc oxide (ZnO), barium sulfate (BaSO₄), calcium sulfate (CaSO₄), magnesium carbonate (MgCO₃), aluminum hydroxide (Al(OH)₃) and clay.

The size and concentration of the diffusing agent are factors in determining the scattering degree of incident light from a light source. When the amount of the diffusing agent is too low, the diffusion efficiency of light is lowered. In contrast, when the amount of the diffusing agent is too high, light transmittance is lowered. In embodiments of the present invention, SiO₂ beads exhibited the desirable properties when having a diameter size of about 5 to 7 μm. In addition, the diffusing agent exhibited high light diffusion and transmittance when concentration of the SiO₂ beads was at about 12% to 14%.

Similar to the diffusing agent, the phosphor size is also a factor in determining the quality of output light. The phosphor size is within a range of about 5 to 7 μm. When the phosphor size is too small, photoluminescent efficiency is decreased. In contrast, when the phosphor size is too large, light transmittance and thickness uniformity of the resulting photoluminescent film are decreased.

The resin matrix used in embodiments of the present invention is a silicone resin film 5, as shown in FIG. 1. The silicone resin film 5 has desirable softness and excellent adhesion upon printing on a base film. Preferred properties of the silicone resin film that can be utilized in embodiments of the present invention are light transmittance of more than 85%, viscosity of more than 3,000 cps and a drying (curing) capability at a temperature of lower than 150° C. In addition, the silicone resin film should have desirable miscibility with phosphors, lower volatility, a longer pot-life and good adhesion with the base film.

The silicone resin film 5 may include, for example, resins having HO(Me)₂SiO(Me₂SiO)ₙ(Me)₂SiOH and Me₃SiO(MeHSiO)nSiMe₃ as a basic structure to which a small amount of RSi(OR′)ₙ where R′ is alkyl or acetyl and R₂Sn(OC═OR′)₂ are added as additives, or resins having CH₂═CH(Me)₂SiO(Me₂SiO)nSi(Me)₂CH═CH₂ and Me₃SiO(MeHSiO)nSiMe₃ as a basic structure to which a small amount of [CH₂═CH(Me)₂SiOSi(Me)₂CH═CH₂]ₙPt is added as an additive. Such resins are commercially available on the market and include, for example a silicone resin system LS4326 (silicone resin)-LS4326A (a curing agent)-LS4326C (hardening accelerator)-toluene or xylene (70%, a viscosity modifier or solvent) (Dow Corning, USA), a silicone resin system CF5010 (a silicone resin)-SO400 (a curing agent)-silicone oil (a viscosity modifier or solvent) (Dow Corning, USA), and a silicone resin system DC76570 (a silicone resin)-SO400 (a curing agent)-silicone oil(a viscosity modifier or solvent), DC9800 Part A (a silicone resin)-DC9800 Part B (a curing agent) (Dow Corning, USA). These silicone resins contain a defoaming agent and therefore it is possible to solve problems associated with non-uniformity due to production of bubbles that may occur in screen printing. To manufacture uniform films via smooth mixing between other liquid silicone resin and phosphors (excitation materials) and/or diffusing agents and/or to prevent generation of bubbles, an anti-precipitation agent, a binder, an antifoaming agent and an additive capable of controlling volatility may be incorporated into the silicon resin.

Resins, which can be utilized as the base film 10 in embodiments of the present invention, are colorless and transparent synthetic resins having desirable light transmittance and include, but are not limited to, polyethylene terephthalate (PET), polyethylene naphthalate, acrylic resins, polycarbonate and polystyrene, for example. Among these resins, the polyethylene terephthalate (PET) film exhibits desirable transparency, strength and flexibility. In addition, where heat resistance and chemical resistance are required, the base film may be made of polycarbonate.

The base film can contain diffusion material so as to be a base diffusion layer. A silicon photoluminescent that does not contain any diffusing agents can be combined with a base diffusion layer. Further, the base film 10 can be a diffusion layer that is combined with a silicone photoluminescent layer that does contain a diffusing agent.

The thickness of the base film may be within the range of 10 to 50 μm. Where the thickness of the base film is less than 10 μm, it is difficult to handle. In contrast, when the thickness of the base film is greater than 50 μm, light transmittance will be decreased. However, if the liquid silicone mixture is to be printed on the base film, a supplementary release film is added to the base film so as to have an overall thickness of more than 50 μm for protection, prevention of contamination and serving to assist in printing the liquid silicone mixture onto the base film. A roll-to-roll type deposition process of the liquid silicone mixture does not suffer from problems associated with printing the liquid silicone mixture, and thus a roll-to-roll type process does not necessarily need the supplementary release film. A film having a thickness of less than 50 μm can be difficult to handle during printing of the liquid silicone mixture and thus a supplementary release film is added to create a two-layer film having a combined thickness of more than 50 μm.

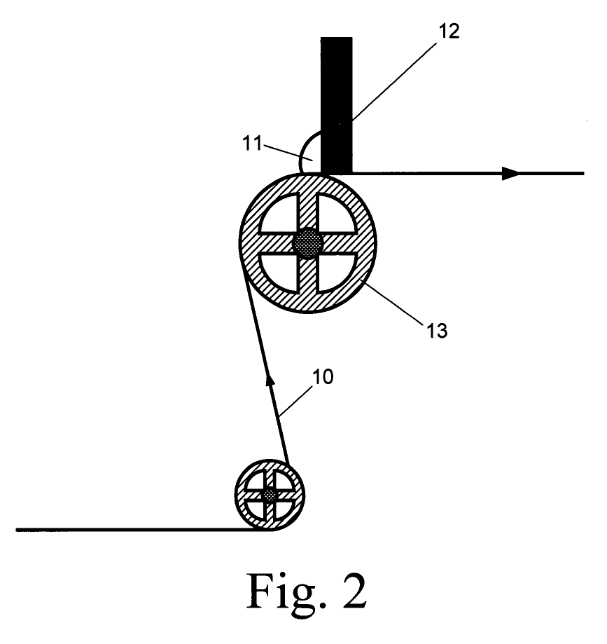

As mentioned above, the liquid silicone mixture can be applied to the base film using roll-to-roll type processes, such as knife coating, reverse roll, roll coating, calendar coating, curtain coating, extrusion coating, cast coating, inverted rod coating, engraved-roll coating, dip coating and slit coating. FIG. 2 shows a knife over roll coating method for applying a liquid silicone mixture to a base film. The knife over roll coating method is the most widely used method. The amount of coating resin 11 is controlled by the gap between a knife 12 and a lower roller 13. Coating quality depends upon angle and shape of the knife, transit time of the base film 10, and rheological properties of the coating resin 11. The coating resin can be applied to a thickness of about 0.1 inch.

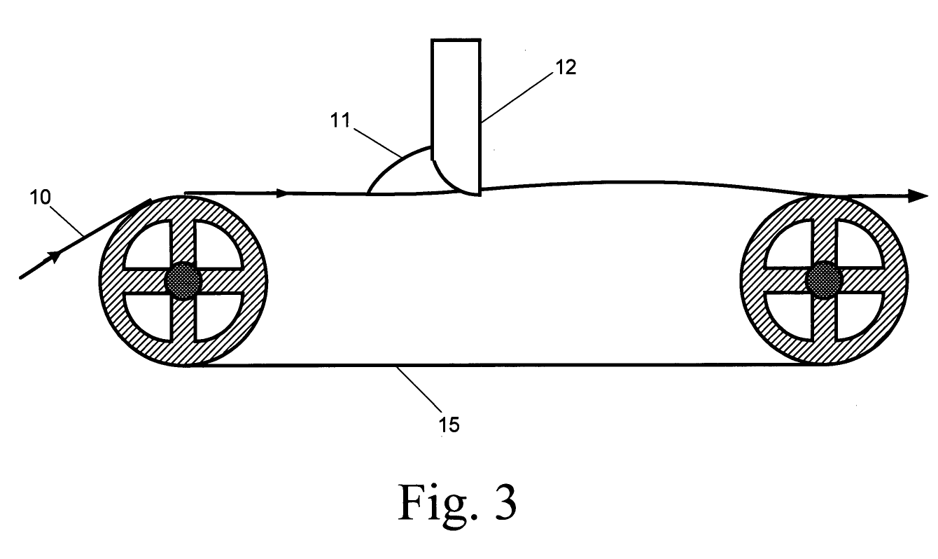

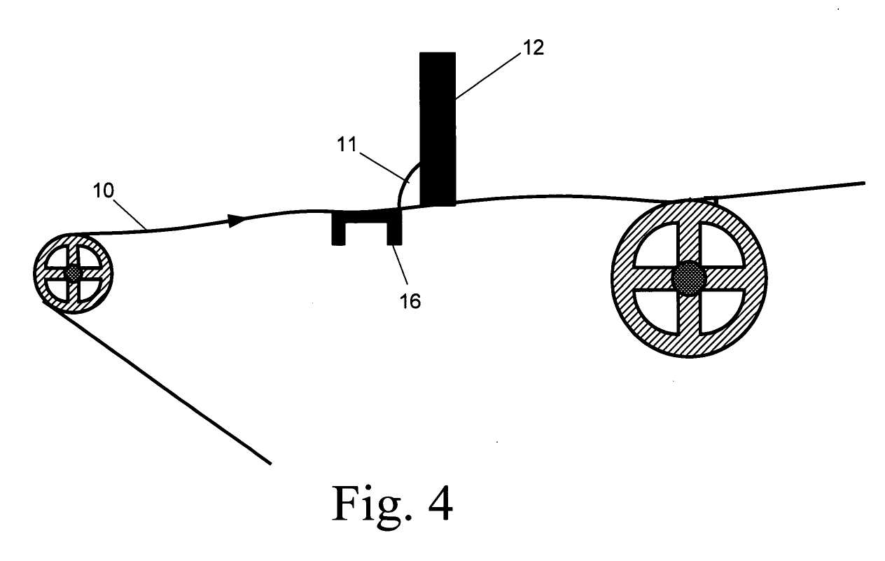

FIG. 3 shows a knife over table coating method for applying a liquid silicone mixture to a base film 10. The knife over table coating method is similar to the knife over roll method, except that the moving base film 10 is supported by a rubber blanket or table 15 while the coating resin 11 is applied. FIG. 4 shows a floating knife coating method for applying a liquid silicone mixture to a base film. The floating knife coating method is primarily used when it is desired to coat fillers. Unlike the knife over table coating method, the coating resin 11 is applied to the base film 10 directly moving over a pan 16 at the rear side of the knife 12.

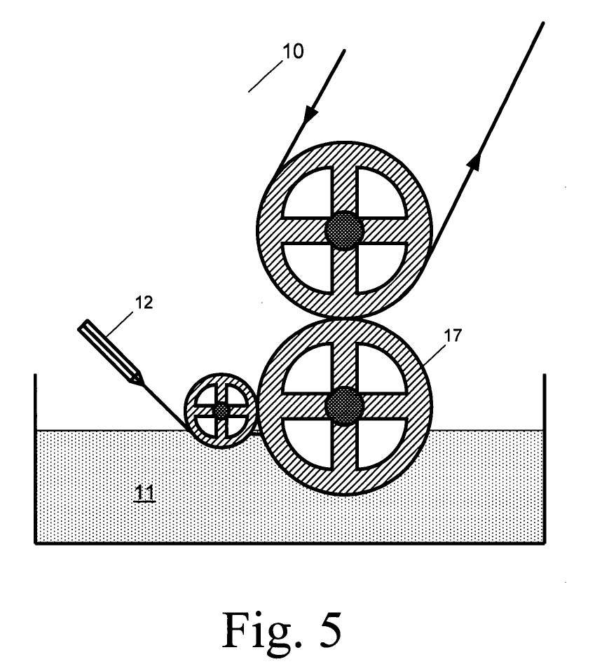

FIG. 5 shows an L-head reverse roll coater method for applying liquid silicone mixture to a base film. In the L-shape head reverse roll coater method, materials are supplied to the base film 10 fabrics from a coating pan via a transfer roll 17. Due to the use of the supply pan, the composition of coating materials is uniformly controlled by filtration. It is also possible to recycle materials, control heat and stabilize viscosity by monitoring the coating resin.

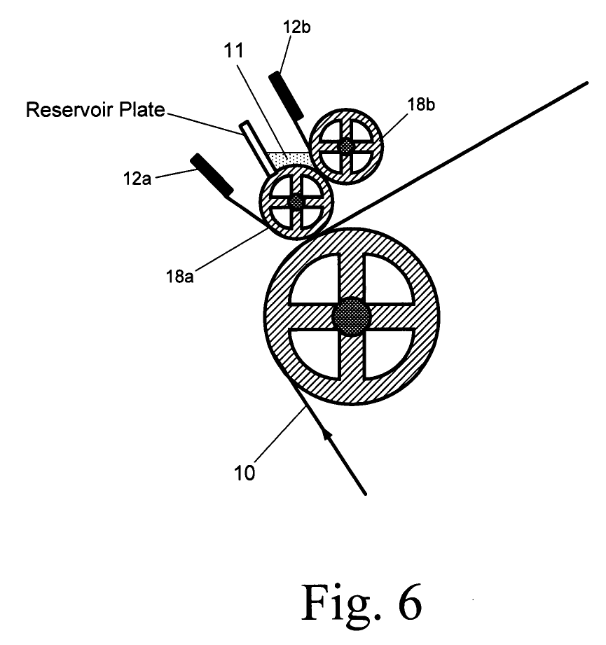

FIG. 6 shows a nip-fed reverse roll coater method for applying liquid silicone mixture to a base film. The operation principle of a nip-fed reverse roll coater is identical to that of the L-shape head reverse coater, except that rolls are arranged to immediately apply significantly less of the coating resin 11. In this apparatus, the coating amount is exactly determined by two rolls 18a and 18b over knives 12a and 12b. Coating resin 11 is applied to the base film 10 passing beneath the rolls 18a and 18b.

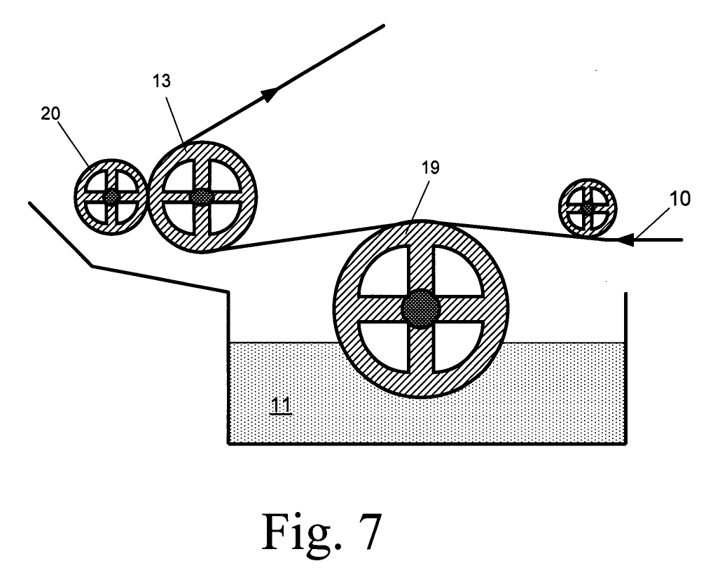

FIG. 7 shows a pan-fed reverse roll coater method for applying liquid silicone mixture to a base film. Modification of reverse roll coating methods may be made in various ways and one example is a pan-fed (Levelon) reverse roll, as shown in FIG. 7. When the coating resin 11 is applied to the base film 10 via coating roll 19 and then passed through a metering roll 20 and rubber backing roll 14, excess coating resin is removed and smooth surface treatment is effected. Where the surface of the backing roll 13 is covered with elastic materials such as rubber, it is possible to control the coating thickness by controlling pressure of a nip. As pressure of the nip rises and rotation speed of the roll is increased, the amount of coating agent removed is increased.

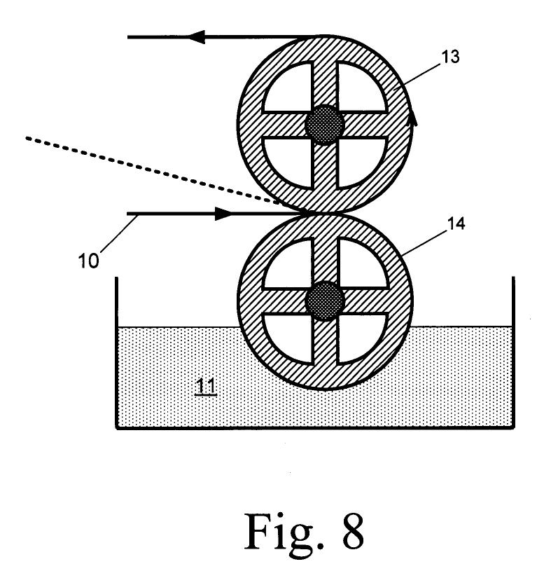

FIG. 8 shows a roll coating method for applying liquid silicone mixture to a base film. In roll coating, a backing roll 13 and an applicator roll 19 are vertically arranged one above the other, as shown in FIG. 8. Thus, it is possible to perform one-sided or double-sided coating by changing an access angle of the base film 10. Since most coating materials are softened by heat, materials are melted and compressed between heated metal calendar rolls, and are coated into a sheet form.

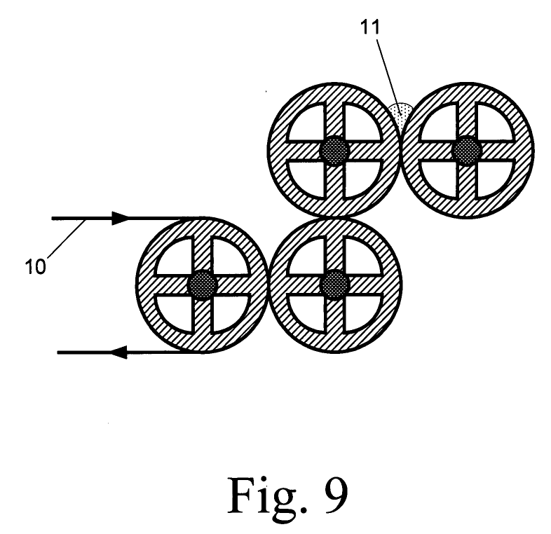

FIG. 9 shows a calendar coating method for applying liquid silicone mixture to a base film. Calendar coating applies coating materials in a molten state and therefore is largely employed in coating vinyl plasticizers or thermoplastic resins on base films. As shown in FIG. 9, calendar coating involves L-shaped or Z-shaped arrangement of four rolls. Therefore, the resin coating 11 passes between a pair of rolls and is extruded into a thin film and transferred to the adjacent next pair of rolls while being transferred to the base film 10. This method is primarily employed in thick coating.

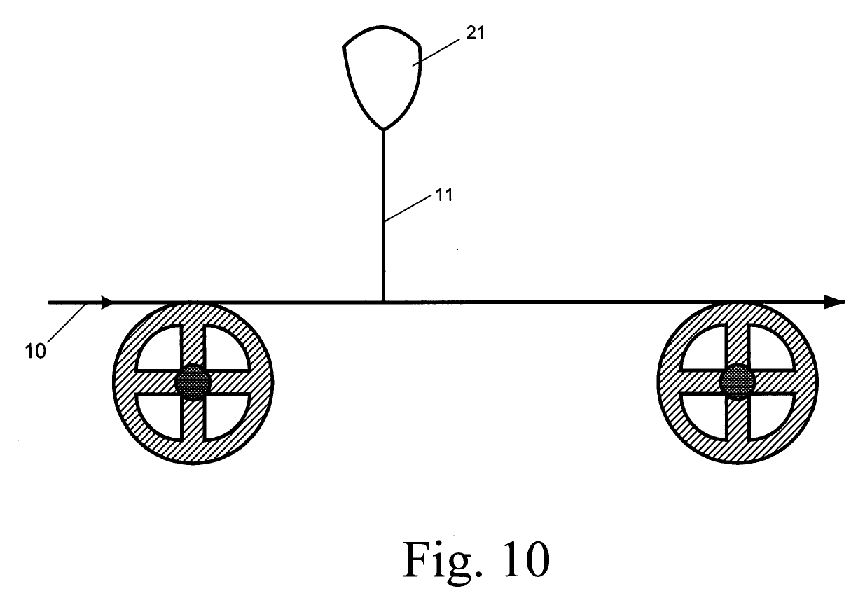

FIG. 10 shows a curtain coating method for applying liquid silicone mixture to a base film. In curtain coating, the coating amount is not controlled by a knife or roll system, rather, the coating resin is passed through a die by pressure and applied in the form of a sheet onto the moving base film. Curtain coating can also be used to coat continuous smooth base films as well as base films having irregularities, such as waves.

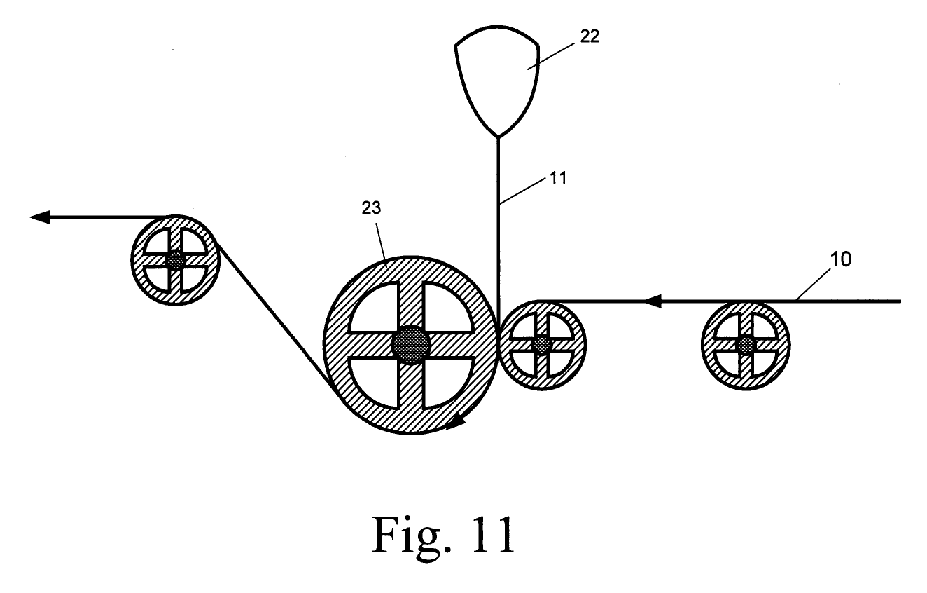

FIG. 11 shows an extrusion coating method for applying liquid silicone mixture to a base film. Extrusion coating is a method employed when thermoplastic materials, such as vinyl or polyethylene are used as a coating resin. In this method, coating resin 11 is coated in the form of film on the base film 10 via a flat extrusion die 22 by pressure and then cooled by a chilled drum 23.

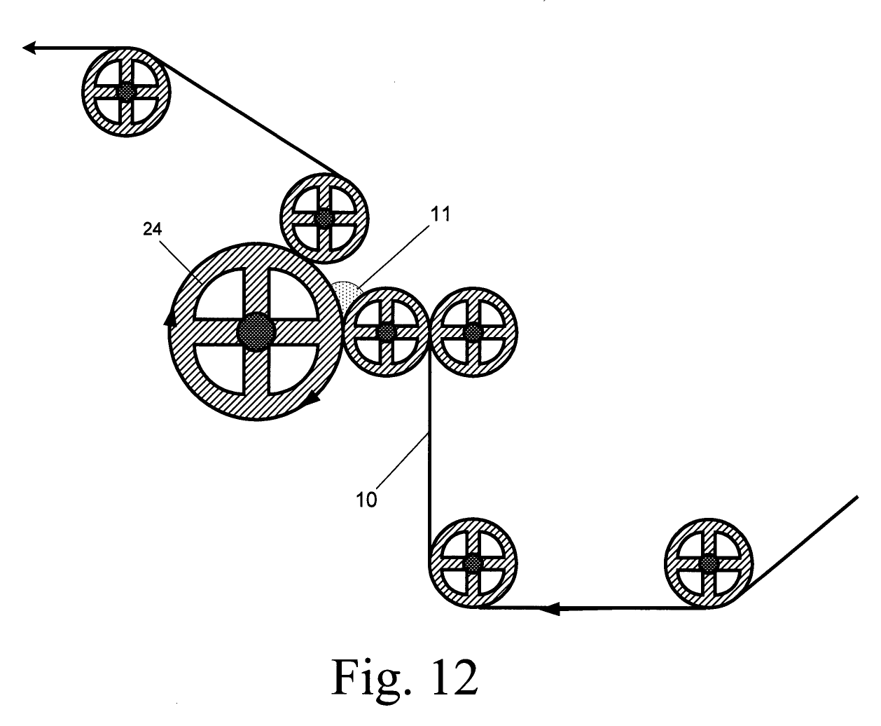

FIG. 12 shows an extrusion coating method for applying liquid silicone mixture to a base film. Most materials capable of forming films can be subjected to cast coating. As shown in FIG. 12, a coating resin 11 is applied to the base film 10, which is in contact with a heated drum 24. Then, the coating resin 11 is cured in the course of passing on the heating drum 24. Cast coating achieves a very smooth coated surface. Cast coating provides advantages, such as precise control of coating thickness and capability to prepare a smooth coated surface even when the base film 10 surface is rough or irregular.

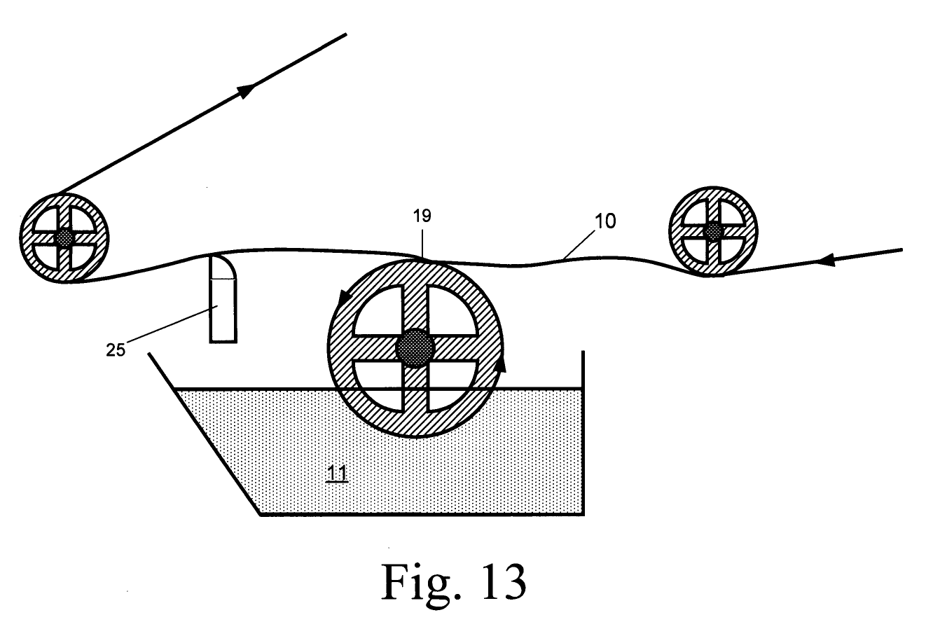

FIG. 13 shows an inverted rod coating method for applying liquid silicone mixture to a base film. Inverted rod coating is a variant of the floating knife method. A wire wound doctor 25 controls an amount of materials to be coated on a bottom surface of a base film 10. The coating amount is determined by tension of the base film 10. When a mayer rod is employed, the coating amount is controlled by specification of a wire, and a winding number of the wire per inch of the rod. FIG. 13 shows a wire wound rod coater. Excess coating resin 11, transferred to the base film 10 by an applicator roll 19, is removed by the wire wound doctor 25.

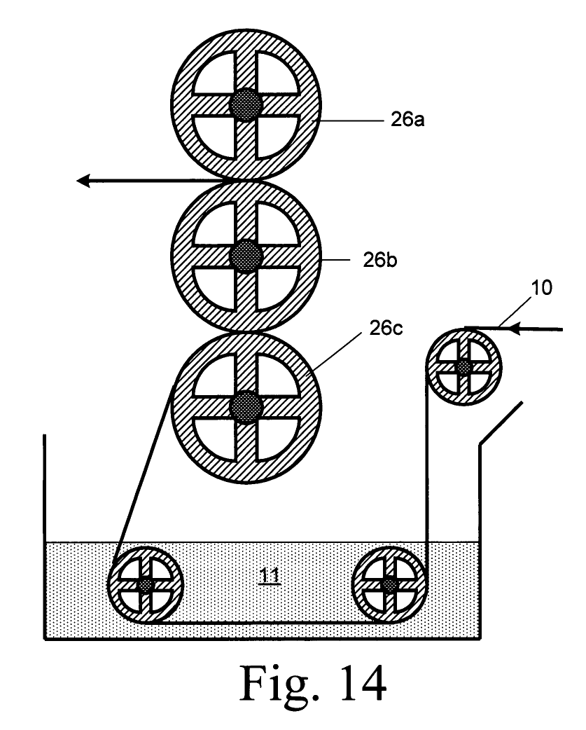

FIG. 14 shows a dip coating method for applying liquid silicone mixture to a base film. In dip coating, the coating compound coats both sides of the base film 10 using three nip rolls 26a, 26b and 26c. Therefore, a ratio of amount of coating compound used relative to base film length covered is increased. Pretreatment of a wetting agent prior to dipping removes bubbles on the base film, resulting in significantly easier coating of the coating compound.

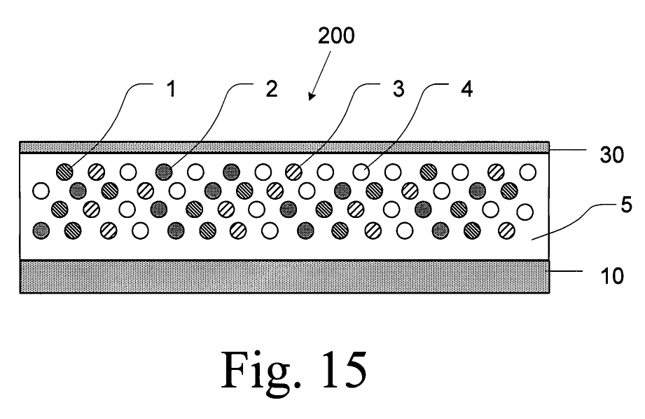

FIG. 15 is a silicone photoluminescent diffusion layer according to a second embodiment of the present invention. As shown in FIG. 15, the silicone photoluminescent diffusion layer 200 according to the second embodiment of the present invention includes a silicone resin film 5, which is positioned on a base film 10. The silicone resin film 5 contains photoluminescent materials and diffusion materials. Both of the photoluminescent materials and the diffusion materials are distributed throughout the silicone resin film 5. The photoluminescent materials can include yellow phosphors 1, green phosphors 2 and red phosphors 3. Further, the photoluminescent materials can include blue phosphors. The diffusion materials are light diffusing agents 4. The second embodiment 200 further includes a protection film 30 on the photoluminescent diffusion layer 200. The protective film 30 on the photoluminescent diffusion layer 200 in accordance with the second embodiment of the present invention can be laminated on the photoluminescent diffusion layer 200. Preferably, the protective film 30 is laminated on the photoluminescent diffusion layer 200 right after it cures to avoid effects of dust, moisture and any other foreign materials on the photoluminescent diffusion layer 200.

Resins, which can be utilized as the protective film 30, are colorless and transparent synthetic resins having desirable light transmittance and include, but are not limited to, polyethylene terephthalate (PET), polyethylene naphthalate, acrylic resins, polycarbonate and polystyrene, for example. Among these resins, the polyethylene terephthalate (PET) film exhibits desirable transparency, strength and flexibility. In addition, where heat resistance and chemical resistance are required, the base film 10 can be made of polycarbonate. The thickness of the protective film can be within the range of 10 to 50 μm. This protective film can also have a protective release film with a thickness of more than 50 μm for protection and prevention of contamination. This protective film is designed for protecting the photoluminescent diffusion film and is fabricated to a thickness capable of protecting the photoluminescent diffusion film against dust, moisture and any other foreign materials, without affecting light transmittance and other optical factors.

As discussed above, the liquid silicone mixture for manufacturing the photoluminescent diffusion layer can be printed on the base film. Either screen printing or gravure printing can be used. Since a polymeric printing plate employed in screen printing exhibits weak mechanical strength and is limited in controlling the thickness of the photoluminescent diffusion layer, a stainless plate can be used for efficiency of mass production. The mesh size of the printing plate depends upon the printed thickness of the liquid silicone mixture. A printing plate having a mesh size of about 50 to 120 μm can be used to manufacture embodiments of the present invention.

The liquid silicone mixture for printing or coating is made by made by making a mixture of a silicone resin gel, a curing agent, a hardening accelerator, an anti-foaming agent and phosphors (excitation materials). A diffusing agent can be added to the mix if light diffusion is desired in the layer. If a diffusing agent is added, a photoluminescent diffusion layer will be manufactured. However, if the diffusing agent is not added, only a photoluminescent layer will be manufactured. In this case, for purposes of explanation, the diffusing agent will have been added. A viscosity modifier such as silicone oil is added to adjust viscosity of the resulting mixture, thereby preparing a liquid silicone mixture material. Then, the thus-prepared liquid silicone mixture material is printed or coated on a base film via coating methods or screen printing methods. Then, a protective film can be laminated thereon. The resulting photoluminescent diffusion layer is then cut to a size suited to a back light unit. This is followed by removal of the supplementary release films attached to the base film and protective film, respectively, thereby completing manufacture of the photoluminescent diffusion layer 200.

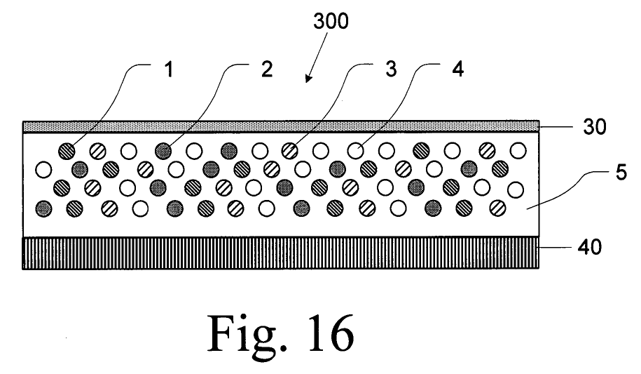

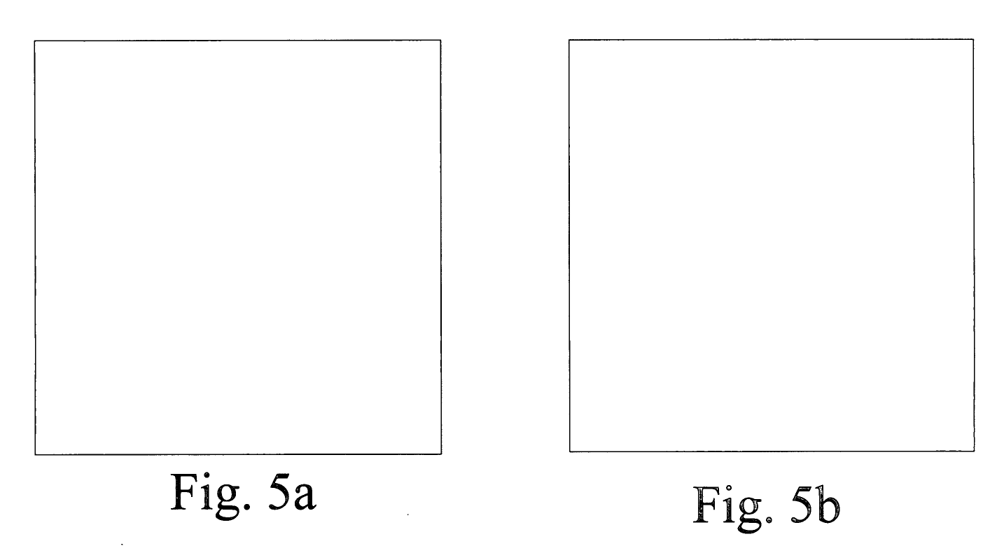

FIG. 16 is a silicone photoluminescent diffusion layer according to a third embodiment of the present invention. As shown in FIG. 16, the silicone photoluminescent diffusion layer 300 according to the second embodiment of the present invention includes a silicone resin film 5, which is positioned on a light guide panel 40. The silicone resin film 5 contains photoluminescent materials and diffusion materials. The photoluminescent materials can include yellow phosphors 1, green phosphors 2 and red phosphors 3. Further, the photoluminescent materials can include blue phosphors. The diffusion materials are light diffusing agents 4. The second embodiment 300 further includes a protection film 30 similar to the second embodiment of the invention.

The photoluminescent diffusion layer in embodiments of the present invention may be fabricated in the form of a stand alone sheet, or may be directly formed on a light guide panel of a back light device. When the photoluminescent diffusion layer is fabricated in the form of a sheet, the base film may be an organic resin film or a light guide panel. When the photoluminescent silicone resin is directly applied to the back light, the light guide panel of the back light serves as the base film.

When the photoluminescent diffusion layer in accordance with embodiments of the present invention is prepared on an organic resin film, the base film is preferably composed of PET or PC. When the liquid silicone mixture is directly applied to the back light, the light guide panel of the back light can be made of PMMA or PC. Formation of the silicon resin film on the organic base film can be carried out by both coating methods and printing methods. When the silicon resin film is to be positioned on the light guide panel of a back light, the silicon resin film is formed by printing. Now, embodiments of the present invention will be described in more detail with reference to the following examples. These examples are provided only for illustrating embodiments of the present invention and should not be construed as limiting the scope and spirit of the present invention.

### EXAMPLE 1

About 0.5% by weight of SO400 was added to DC76570 based on 100% by weight of DC76570 to prepare a liquid silicone resin. The addition ratio of the above SO400 additive may vary depending upon progress conditions. The liquid silicone resin was mixed with about 13% by weight of (Y, Gd, Ce)₃ (Al, Ga)₅O₁₂ (Daejoo Electronic Materials Co., Ltd., Korea) and Y₃Al₅O₁₂:Ce (Phosphor Technology Ltd., England) as phosphors, and about 13% by weight of SiO₂ beads having a diameter of about 5 to 7 μm as a diffusing agent, based on 100% by weight of the liquid silicone resin. Thus, the weight of the SiO₂ is about the same as the weight of the diffusing agent. This mixture was stirred into a liquid silicone mixture using a rotating/revolving stirrer.

Then, the liquid silicone mixture was applied on a printing surface, such as the first layer of a PET film having a bilayer structure in which the first layer has a thickness of about 25 μm and the second release layer has a thickness of about 75 to 100 μm, via screen printing, and was then cured in an infrared drying oven at a temperature of about 120° C. Then, a protective film was laminated on the prepared silicon resin film using a laminator. The resulting photoluminescent diffusion layer was then cut to a size suited to a back light unit. This was followed by removal of the supplementary release films attached to the base film and the protective film, respectively, so as to complete manufacturing of a photoluminescent diffusion.

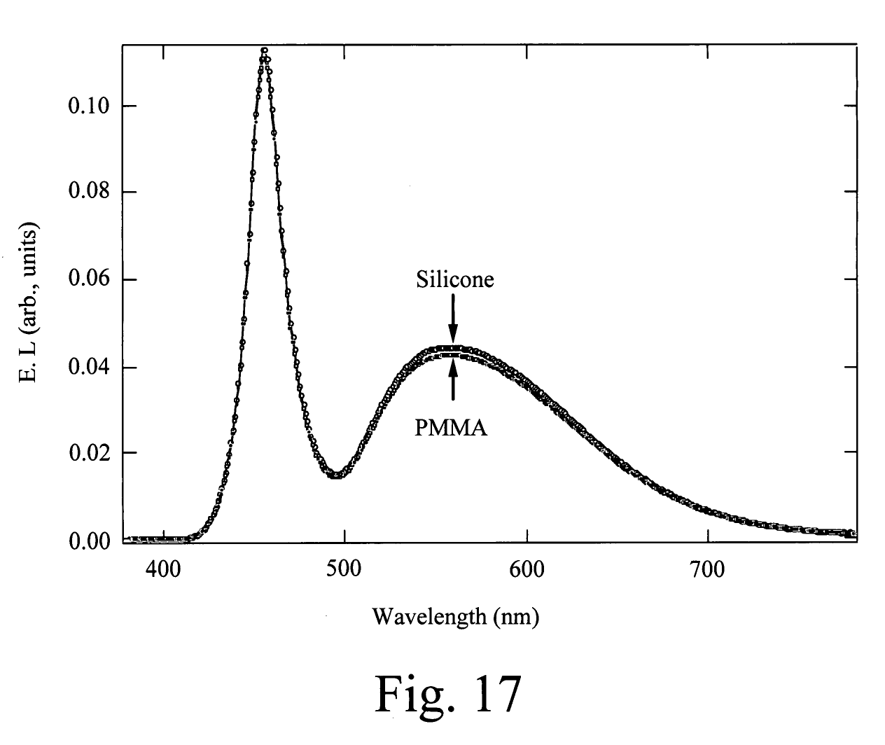

The brightness of the above-prepared silicon photoluminescent diffusion layer was measured in comparison to a PMMA photoluminescent diffusion layer (IF850, LG Chemical Co. Ltd., Korea). FIG. 17 is optical spectra illustrating brightness of a silicone photoluminescent diffusion layer and a PMMA photoluminescent diffusion layer. The results, as depicted in the graph of FIG. 17, show that the silicone photoluminescent diffusion layer in embodiments of the present invention has desirable optical properties as compared to the PMMA photoluminescent diffusion layer. In addition, the PMMA photoluminescent diffusion layer was broken at a bending force that the silicone photoluminescent diffusion layer in embodiments of the present invention was able to withstand without breakage due to its excellent ductility.

### EXAMPLE 2

Grid patterns were formed on the surface of a photoluminescent diffusion layer in the following manner. About 0.5% by weight of LS4326A and about 2% by weight of LS4326C were sequentially added to LS4326 based on 100% by weight of LS4326 to make a liquid silicone resin. The addition ratio of the above additives may vary depending upon progress conditions. To satisfy conditions for producing grid patterns on a printing surface, the liquid silicone resin requires viscosity of more than 3,000 cps. In this example, viscosity was adjusted to about 5,000 cps using toluene and the mesh size of the printing plate was about 20. When the viscosity of the liquid silicone resin is less than 3,000 cps, it is difficult to achieve smooth formation of grid patterns. Thus, viscosity is an important factor for the formation of grid patterns. The liquid silicone resin prepared above was mixed with about 13% by weight of (Y, Gd, Ce)₃ (Al, Ga)₅O₁₂(Daejoo Electronic Materials Co., Ltd., Korea) and Y₃Al₅O₁₂:Ce (Phosphor Technology Ltd., England) as phosphors, and about 13% by weight of SiO₂ (about 5 to 7 μm) as a diffusing agent, based on 100% by weight of the liquid silicone resin. The resulting mixture was stirred using a rotating/revolving stirrer to form a liquid silicone mixture.

Then, the liquid silicone resin was applied on a printing surface, such as a first layer of a PET film having a bilayer structure in which the first layer has a thickness of about 25 μm and second release layer has a thickness of about 75 to 100 μm, via screen printing, and was then cured in an infrared drying oven at a temperature of about 120° C. to form a silicone resin film. Then, a protective film was laminated on the prepared silicone resin film using a laminator. The resulting silicone photoluminescent diffusion layer and was cut to a size suited to a back light unit. This was followed by removal of the supplementary release films attached to the base film and protective film, respectively, so as to finalize manufacturing of the photoluminescent diffusion layer.

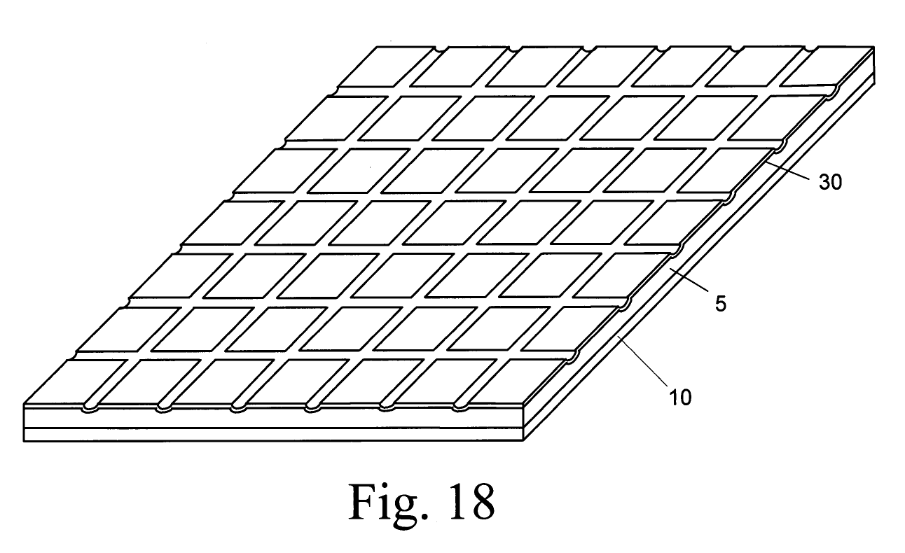

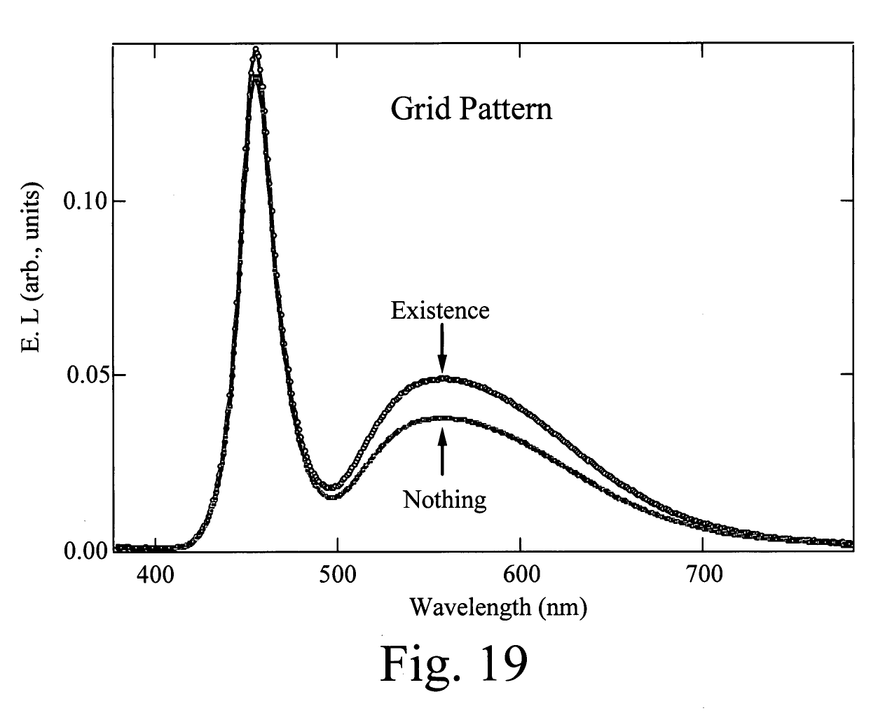

FIG. 18 shows a photoluminescent diffusion layer according to a fourth embodiment of the present invention. As shown in FIG. 18, the silicone photoluminescent diffusion layer 400 according to a fourth embodiment of the present invention includes a silicone resin film 5, which is positioned on a base film 10. The silicone resin film 5 has a top surface with a grid pattern and contains both phosphors and a diffusing agent. A protective layer 20 is laminated on the top surface of the silicon resin film 5 having the grid pattern. FIG. 19 is optical spectra illustrating brightness when the photoluminescent diffusion layer was fabricated via screen printing with and without grid patterns. The grid patterned photoluminescent diffusion layer exhibited increased brightness and chromaticity, as compared to a photoluminescent diffusion layer without grid patterns.

Because geometric patterns can be formed in the photoluminescent layer in embodiments of the present invention, the need for a prism sheet can be eliminated. When using gravure printing, knife coating, reverse roll coating, roll coating, calendar coating, curtain coating, extrusion coating, cast coating, inverted rod coating, engraved-roll coating or dip coating, it is possible to design negative grid patterns or negative optical structures on a surface of the coating roll. Such negative grid patterns or negative optical structures are transferred onto the surface of the photoluminescent layer as the desired grid patterns or optical structures. The optical structures can be pyramids, prisms or a matrix of repetitive patterns, such as inverted cones. The grid patterns can be any polygonal shape.

### EXAMPLE 3

Optical properties of photoluminescent diffusion layers were compared utilizing various kinds of diffusing agents. About 0.5% by weight of LS4326A and about 2% by weight of LS4326C were sequentially added to LS4326 based on 100% by weight of LS4326 to make a liquid silicone resin. In this example, viscosity was adjusted to about 5,000 cps using toluene and a mesh size of a printing plate was set to about 120. The liquid silicone resin thus prepared was mixed with about 13% by weight of (Y, Gd, Ce)₃ (Al, Ga)₅O₁₂ (Daejoo Electronic Materials Co., Ltd., Korea) and Y₃Al₅O₁₂:Ce (Phosphor Technology Ltd., England) as phosphors, without a diffusing agent, and about 13% by weight of SiO₂ beads having about 5 to 7 μm diameter, a PMMA monomer beads having a diameter of about 5 to 7 μm and a PMMA polymer beads having a diameter of about 5 to 7 μm as diffusing agents, respectively, based on 100% by weight of the liquid silicone resin. The resulting liquid silicone mixture was stirred using a rotating/revolving stirrer. Then, the liquid silicone mixture was printed on a surface, such as the top layer of a bilayer PET film in which the top layer has a thickness of about 25 μm and the bottom release layer has a thickness of about 75 to 100 μm, via screen printing, and was then cured in an infrared drying oven at a temperature of about 120° C. Then, a protective film was laminated onto the prepared photoluminescent diffusion film using a laminator. The resulting photoluminescent diffusion layer and was cut to a size suited to a back light unit. This was followed by removal of the supplementary release films attached to the base film and protective film, respectively, to complete manufacturing of the photoluminescent diffusion layer.

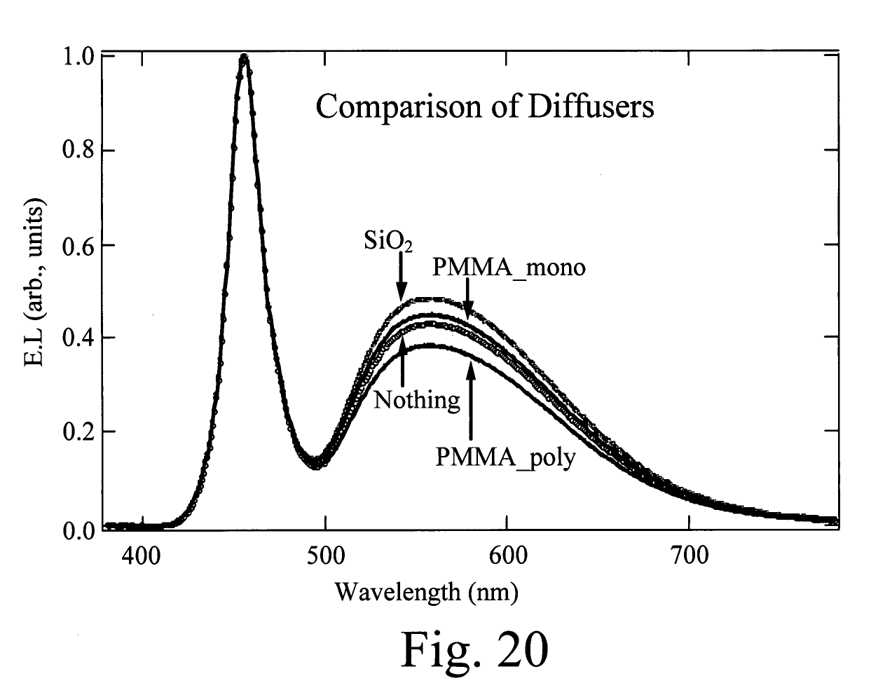

FIG. 20 shows optical spectra of the photoluminescent diffusion layers having different kinds of diffusing agents. The photoluminescent diffusion layers exhibited changes in photoconversion efficiency or brightness thereof, depending upon the kinds of diffusing agents. As shown in FIG. 20, the photoluminescent diffusion layer exhibited desirable optical properties when SiO₂ was used as a diffusing agent.

### EXAMPLE 4

About 0.5% by weight of SO400 was added to CF5010 based on 100% by weight of CF5010 to make a liquid silicone resin. The liquid silicone resin was mixed with about 13% by weight of (Y, Gd, Ce)₃ (Al, Ga)₅O₁₂ (Daejoo Electronic Materials Co., Ltd., Korea) and Y₃Al₅O₁₂:Ce (Phosphor Technology Ltd., England) as phosphors, and about 13% by weight of SiO₂ (about 5 to 7 μm) as a diffusing agent, based on 100% by weight of the liquid silicone resin. The resulting liquid silicone mixture was stirred using a rotating/revolving stirrer. Then, a light guide panel was separated from a commercially available back light unit (LG Electronics, Korea). The liquid silicone mixture was directly applied onto the light guide panel via screen printing and was then cured in an infrared drying oven at a temperature of about 120° C. A protective film was then laminated onto the photoluminescent diffusion film.

In addition, for a photoluminescent diffusion sheet utilizing PET, the liquid silicone mixture was coated on a printing surface, such as a first layer of a PET film having a bilayer structure wherein the first layer has a thickness of about 25 μm and second layer has a thickness of about 75 to 100 μm, via screen printing, and was then cured in an infrared drying oven at a temperature of about 120° C. Then, a protective film was laminated onto the prepared photoluminescent diffusion film using a laminator. The resulting the photoluminescent diffusion layer was cut to a size suited to a back light unit. This was followed by removal of the supplementary release films attached to the base film and protective film, respectively, so as to complete manufacturing of the photoluminescent diffusion layer.

When applying the liquid silicone mixture via direct screen printing to the prepared light guide panel, the composition of the light guide panel has to be taken into consideration. For example, if the light guide panel is made of PMMA or PC, which is soluble in toluene or xylene, it is impossible to use toluene or xylene for viscosity control of the liquid silicone mixture. In such a case, silicone oil should be used to control the viscosity of the liquid silicone mixture.

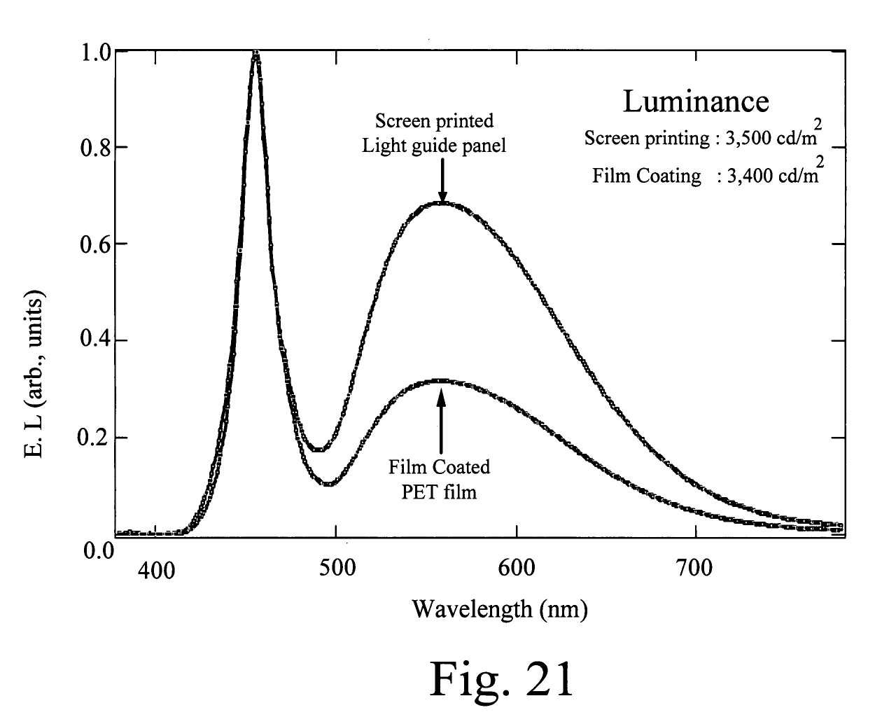

FIG. 21 shows optical spectra of the photoluminescent diffusion layer including a light guide panel as compared to a photoluminescent diffusion layer including a PET film. When the phosphors and diffusing agent were mixed with the liquid silicone mixture under the same conditions, direct screen printing on the light guide panel exhibited superior results in excitation efficiency of phosphors. Such results indicate that direct screen printing on the light guide panel reduces the amount of phosphors needed, which results in increased light transmission from the light source.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A photoluminescent layer, comprising:
a silicone resin film;
at least one color of phosphors distributed throughout the silicone resin film; and
a base film on a first surface of the silicone resin film.

2. The photoluminescent diffusion layer according to claim 1, wherein the base film includes one of polyethylene terephthalate, polyethylene naphthalate, acrylic resin, polycarbonate and polystyrene.

3. The photoluminescent layer according to claim 1, further comprising a diffusing agent distributed throughout the base film.

4. The photoluminescent layer according to claim 1, further comprising a diffusing agent distributed throughout the silicone resin film.

5. The photoluminescent layer according to claim 4, wherein a first weight of the at least one color of phosphors are about the same as a second weight of the diffusing agent.

6. The photoluminescent layer according to claim 4, wherein the diffusing agent is silicon dioxide beads.

7. The photoluminescent layer according to claim 6, wherein the silicon dioxide beads have a diameter of about 5 to 7 μm.

8. The photoluminescent layer according to claim 1, wherein the at least one color of phosphors are beads having a diameter of about 5 to 7 μm.

9. The photoluminescent layer according to claim 8, wherein the at least one color of phosphors are red, blue and green phosphors.

10. The photoluminescent layer according to claim 9, further comprising a blue color phosphors distributed throughout the silicone resin film.

11. The photoluminescent layer according to claim 1, wherein a second surface of the silicone resin film opposite to the first surface has a pattern.

12. The photoluminescent layer according to claim 1, further comprising a protective film laminated over the silicon resin film.

13. The photoluminescent layer according to claim 1, wherein the silicone resin has a light transmittance of more than 85% and a viscosity of more than 3,000 cps.

14. A photoluminescent layer, comprising:
a light guide panel;
a silicone resin film on the light guide panel; and
at least one color of phosphors distributed throughout the silicone resin.

15. The photoluminescent diffusion layer according to claim 14, wherein the light guide panel is a part of a back light unit.

16. The photoluminescent layer according to claim 14, further comprising a diffusing agent distributed throughout the silicone resin film.

17. The photoluminescent layer according to claim 16, wherein a first weight of the at least one color of phosphors are about the same as a second weight of the diffusing agent.

18. The photoluminescent layer according to claim 16, wherein the diffusing agent is silicon dioxide beads.

19. The photoluminescent layer according to claim 18, wherein the silicon dioxide beads have a diameter of about 5 to 7 μm.

20. The photoluminescent layer according to claim 14, wherein the at least one color of phosphors are beads having a diameter of about 5 to 7 μm.

21. The photoluminescent layer according to claim 20, wherein the at least one color of phosphors are red, blue and green phosphors.

22. The photoluminescent layer according to claim 21, further comprising a blue color phosphors distributed throughout the silicone resin film.

23. The photoluminescent layer according to claim 14, further comprising a protective film laminated over the silicon resin film.

24. The photoluminescent layer according to claim 14, wherein a second surface of the silicone resin film opposite to the first surface has a pattern.

25. The photoluminescent layer according to claim 14, wherein the silicone resin has a light transmittance of more than 85% and a viscosity of more than 3,000 cps.

26. A method of making a photoluminescent layer, comprising:
mixing photoluminescent materials and liquid silicone resin to produce a liquid silicone mixture;
applying the liquid silicone mixture to a base film; and
curing the applied liquid silicone mixture to form a photoluminescent silicone film on the base film.

27. The method of claim 26, further comprising:
laminating a protective film on the photoluminescent silicone film.

28. The method of claim 26, wherein the applying the silicon solution includes screen printing the liquid silicone mixture onto the base film such that a surface of the photoluminescent silicone film has a pattern.

29. The method of claim 26, wherein the applying the silicon solution includes coating the liquid silicone mixture onto the base film with a coating roll having a negative of a desired pattern such that a surface of the photoluminescent silicone film is formed to have the desired pattern.

30. The method of claim 26, wherein the mixing photoluminescent materials with liquid silicone resin to produce a liquid silicone mixture includes mixing a diffusing agent with the liquid silicone resin.

31. A method of making a photoluminescent layer, comprising:
mixing photoluminescent materials and liquid silicone resin to produce a liquid silicone mixture;
applying the liquid silicone mixture to a light guide plate;
curing the applied liquid silicone mixture to form a photoluminescent silicone film on the base film.

32. The method of claim 31, further comprising:
laminating a protective film on the photoluminescent silicone film.

33. The method of claim 31, wherein the applying the silicon solution includes screen printing the liquid silicone mixture onto light guide plate such that a surface of the photoluminescent silicone film has a pattern.

34. The method of claim 31, wherein the mixing photoluminescent materials with liquid silicone resin to produce a liquid silicone mixture includes mixing a diffusing agent with the liquid silicone resin.
